(19) United States
(12) Patent Application Publication
(10) Pub. No.: US 2014/0242247 A1
(43) Pub. Date: Aug. 28, 2014

(54) NUTRITIONAL COMPOSITIONS

(71) Applicant: SIS (Science in Sport) Limited, Nelson (GB)

(72) Inventors: Timothy John Lawson, Nelson (GB); Alan Whitfield, Nelson (GB); Simon James Lawson, Nelson (GB)

(73) Assignee: SIS (Science in Sport) Limited, Nelson (GB)

(21) Appl. No.: 14/069,830

(22) Filed: Nov. 1, 2013

Related U.S. Application Data
(63) Continuation of application No. 12/161,233, filed on Oct. 2, 2009, now abandoned.

(30) Foreign Application Priority Data
Jan. 18, 2006 (GB) 0601003.7

(51) Int. Cl. A23L 1/29; A23L 1/0522; A23L 1/054; A23L 1/05

(52) U.S. Cl. CPC A23L 1/29; A23L 1/05; A23L 1/0522; A23L 1/0541; A23L 1/0545
USPC 426/578; 426/573

(57) ABSTRACT

There is provided a method of manufacturing a nutritional composition comprising carbohydrate in an amount of at least 250 g l⁻¹ of composition. The method comprises the steps of: (i) combining a first gelling agent and water; (ii) heating the mixture produced in step (i) to a temperature of between 60° C. and 100° C.; (iii) combining a second gelling agent with the heated mixture of step (ii) with mixing; and (iv) maintaining the mixture produced in step (iii) at a temperature of between 70° C. and 100° C. for between 10 and 120 minutes; with a carbohydrate component being combined with the mixture during one or more of said steps. Also provided is a nutritional composition.

### FIELD OF THE INVENTION

The invention relates to methods of manufacturing nutritional compositions, particularly isotonic gels, and to nutritional compositions.

### BACKGROUND TO THE INVENTION

When people exercise they perspire and the resultant loss of water may lead to dehydration, impaired heat dissipation, reduced exercise performance and potential health problems. Prolonged exercise may also deplete the carbohydrate energy stores of the body leading to reduced exercise performance. Ingesting both fluid and carbohydrate during exercise can replace some of the fluid lost and the energy stores used up and may enhance performance.

Ingesting water during exercise will restore fluid lost through sweat. The rate at which fluid balance is restored is determined by the rate at which ingested fluid empties from the stomach and is absorbed from the intestine into the blood. A key factor influencing gastric emptying is the volume of fluid in the stomach. However the rate of gastric emptying may be slowed proportionately with increasing glucose concentration above 80 g l⁻¹. The composition of foodstuffs ingested during exercise may thus have a significant influence on fluid and energy replacement.

The addition of carbohydrate to a fluid, replacement may enhance intestinal absorption rate, as well as maintaining blood glucose concentration and enhancing carbohydrate oxidation. ACSM guidelines recommend the ingestion of 30-60 g/hr of carbohydrate throughout continuous moderate-to-high intensity exercise. Combining this with the consumption of water and electrolyte in the correct proportions may allow the maintenance of optimum performance.

The availability of adequate fluid and energy replacement can be limited to exercise environments by factors such as rules governing rest periods, or locations of aid stations on a race course, etc. To optimise this replacement several different electrolyte energy sources have been developed to aid fluid and energy replacement.

Known fluid replacements may be effective at allowing water and an energy source to be consumed simultaneously. However, there are situations where athletes and active people wish to take on board a concentrated energy source. Known fluid replacements may not be suitable for this purpose.

It is known for athletes and active people to consume concentrated energy sources provided in the form of solid carbohydrates or gels that are hypertonic. However, these may cause problems associated with slow gastric emptying. They may also compromise hydration unless imbibed with significant quantities of hypotonic solution at the same time.

It is desirable for sports people to be able to separate the time when they consume a significant energy source from that at which they consume other fluids. Manufacturing a nutritional product which meets these requirements has however proved a challenge.

Accordingly, the present invention aims to address at least one disadvantage associated with the prior art whether discussed herein or otherwise.

### SUMMARY OF THE INVENTION

According to a first aspect of the present invention there is provided a method of manufacturing a nutritional composition comprising carbohydrate in an amount of at least 250 g l⁻¹ of composition, said method comprising the steps of

(i) combining a first gelling agent and water;
(ii) heating the mixture produced in step (i) to temperature of between 60° C. and 100° C.;
(iii) combining a second gelling agent with the heated mixture of step (ii) with mixing; and
(iv) maintaining the mixture produced in step (iii) at a temperature of between 70° C. and 100° C. for between 10 and 120 minutes;
and wherein a carbohydrate component is combined with the mixture during one or more of said steps.

Suitably, substantially no carbohydrate component is added during step (i).

Suitably, step (i) comprises combining a first gelling agent, water and a sequestrant with mixing.

Suitably, step (i) comprises combining only water, a first gelling agent and a sequestrant.

The water used in step (i) may comprise water of tap-water quality. Alternatively, the water used in step (i) may comprise de-ionised water. In the case of de-ionised water the addition of sequestrant may be omitted.

Suitably, a carbohydrate component is combined with the mixture during step (iii). Suitably, substantially no carbohydrate component is added until step (iii). Suitably, substantially no carbohydrate component is added after step (iii).

Suitably, step (iii) comprises combining a carbohydrate component and a second gelling agent with the heated mixture of step (ii) with mixing.

Suitably, step (iv) comprises maintaining the mixture produced in step (iii) at a temperature of between 70° C. and 100° C. for between 10 and 120 minutes.

Suitably, step (iv) comprises adding water to the mixture of step (iii).

Suitably, step (iv) comprises maintaining the mixture produced in step (iii) at a temperature of between 70° C. and 100° C. for between 10 and 120 minutes and adding water to maintain the volume of the mixture.

Suitably, the method further comprises the step of:

(v) allowing the mixture of step (iv) to cool and/or separating the mixture into portions and/or filling moulds or containers.

Suitably, the nutritional composition produced by the method comprises carbohydrate in an amount of between 250 g l⁻¹ and 500 g l⁻¹ of composition.

The nutritional composition may comprise carbohydrate in an amount of at least 275 g l⁻¹, for example at least: 300 g l⁻¹; 325 g l⁻¹; 350 g l⁻¹; 375 g l⁻¹; or 400 g l⁻¹ of composition.

Suitably, the nutritional composition produced by the method comprises at least 1000 Kcal l⁻¹ of composition.

Suitably, the nutritional composition produced by the method comprises a gel.

Suitably, the nutritional composition produced by the method is isotonic. Suitably, the composition has a tonicity of no greater than 350 mmol l⁻¹. The composition may for example have a tonicity of between 310 and 320 mmol l⁻¹.

Suitably, the composition has an osmolality of between 270 and 330 mOSmol l⁻¹.

The tonicity and osmolality of the composition may be measured using a Wescor Vapour Pressure Osmometer, using standard techniques as are well understood by those skilled in the art.

Suitably, the method comprises making a nutritional composition which comprises water in an amount of between 50% and 80% by weight, for example between 50% and 70% by weight, for example around 66% by weight.

Suitably, step (i) comprises combining the components with mixing at a temperature of 50° C. or less. Step (i) may be performed at a temperature of 40° C. or less, suitably at 30° C. or less, for example at ambient temperature.

Suitably, in step (i) the components are mixed by stirring. Suitably, the stirring is continuous. Suitably, step (i) uses a high shear mixer to mix the components.

Suitably, in step (i) the components are combined in a jacketed steam pan.

Suitably, the first gelling agent comprises a gum. Suitably the first gelling agent comprises a polysaccharide. Suitably, the first gelling agent comprises gellan gum. The first gelling agent may alternatively comprise xanthan gum but gellan gum may be preferred.

Suitably, the method uses a first gelling agent, for example gellan gum, in an amount of between 0.9 g and 2 g per litre of final composition. The method may use a first gelling agent in an amount of between 0.8 g and 1.6 g per litre of final composition, for example in an amount of around 1.2 g per litre of final composition.

Suitably, the method uses a first gelling agent, for example gellan gum, in an amount of between 0.001 g and 0.005 g per 1 g of carbohydrate component, for example in an amount of around 0.003 g per 1 g of carbohydrate component.

A suitable sequestrant for use in the present invention is sodium citrate.

The combination of a sequestrant, for example sodium citrate, with the first gelling agent, for example gellan gum, may allow the first gelling agent to substantially fully hydrate. The sequestrant may prevent the gelling agent from gelling until substantially fully hydrated. Suitably, cold mixing the gelling agent and sequestrant using a high shear mixer may ensure maximum hydration of the gelling agent.

Suitably, the sequestrant, for example sodium citrate, is used in an amount of between 0.0005 g and 0.005 g per 1 g of carbohydrate component, for example in an amount of around 0.001 g per 1 g of carbohydrate component.

Suitably, the ratio of sequestrant to first gelling agent is between 1:2 and 1:4 by weight, for example around 1:3 by weight.

Suitably, step (i) is performed until the first gelling agent is dispersed, for example for between 5 and 20 minutes.

Suitably, the amount of water used in step (i) corresponds to about 90% of the water content of the final composition produced by the method.

Suitably, step (ii) comprises heating the components to a temperature of between 75° C. and 95° C., for example between 80° C. and 90° C. Step (ii) may be performed at a temperature of at least 75° C., for example at least: 80° C.°; 85° C.; or 90° C. Step (ii) may be performed at a temperature of 95° C. or below, for example at or below: 90° C.; 65° C.; or 80° C.

The use of such temperatures may suitably increase the is rate at which the carbohydrate dissolves and/or disperses.

Suitably, in step (ii) the components are mixed by stirring. Suitably, the stirring is continuous. This may ensure that the mixture is not locally overheated and may minimise the risk of components burning and/or degrading. Suitably, step (ii) uses a high shear mixer to mix the components.

Mixing, suitably stirring, may be continuous from step (ii) through to and including step (iv) of the method.

Suitably, step (ii) is performed in a jacketed steam pan. Suitably, the jacketed steam pan is the same pan in which the components are combined in step (i).

Alternatively, the mixture may be heated by passing it through a heat exchanger. Alternatively, the mixture may be heated using live steam. In that case the steam may also cause the water content of the mixture to increase.

Suitably, step (ii) is performed for between 30 minutes and 120 minutes, for example around 60 minutes. Suitably, carbohydrate component is added steadily over this time. This may ensure that the temperature of the mixture can be maintained, in the desired range when cold carbohydrate is added.

Suitably, step (iii) comprises combining the components with mixing at a temperature of between 75° C. and 95° C., for example between 80° C. and 90° C. Step (iii) may be performed at a temperature of at least 75° C., for example at least: 80° C.°; 85° C.; or 90° C. Step (iii) may be performed at a temperature of 95° C. or below, for example at or below: 90° C.; 85° C.; or 80° C.

Suitably, in step (iii) the components are mixed by stirring. Suitably, the stirring is continuous. Suitably, step (iii) uses a high shear mixer to mix the components.

Suitably, in step (iii) the components are combined in a jacketed steam pan. Suitably, in step (iii) the carbohydrate component and second gelling agent are added to the heated mixture of step (ii). The carbohydrate component and second gelling agent may thus be added into the jacketed steam pan used in step (ii).

Suitably, the method uses carbohydrate in an amount such that it does not exceed its limit of solubility in the nutritional composition. Suitably, the carbohydrate is added gradually to ensure that it dissolves and stays in solution. Use of a high shear mixer may assist to pull the carbohydrate into solution. Suitably, the gelling agents are selected to be compatible with the carbohydrate such that they maintain it in solution.

Suitably, the first and second gelling agents, for example gellan gum and xanthan gum, have a synergistic effect when used together. Suitably, the first gelling agent, suitably gellan gum, is added to the mixture when it is cold and heated. Suitably, the second gelling agent, suitably xanthan gum, is not added until the mixture is heated as it may make a cold mixture too viscous. The combination of gelling agents and method of manufacture of the composition may provide a stable gel. The combination of gelling agents may have good shearing characteristics and gives the nutritional composition good mouth-feel. Suitably, the method does not result in the gelling agents substantially binding water. Instead, the gelling agents may use the space the water provides to stretch out.

Suitably, the second galling agent comprises a gum. Suitably, the second gelling agent is distinct from the first gelling agent. Suitably the second gelling agent comprises a polysaccharide, for example a long chain polysaccharide. Suitably, the second gelling agent comprises xanthan gum.

Suitably, the method uses a second gelling agent, for example xanthan gum, in an amount of between 0.5 g and 2 g per litre of final composition. The method may use a first gelling agent in an amount of between 0.6 g and 1.6 g per litre of final composition, for example in an amount of around 1.2 g per litre of final composition.

Suitably, the method uses a second gelling agent, for example xanthan gum, in an amount of between 0.001 g and 0.005 g per 1 g of carbohydrate component, for example in an amount of around 0.003 g per 1 g of carbohydrate component.

Suitably, the first and second gelling agents are used in a ratio of between 12 and 2:1 by weight, for example around 1:1 by weight.

Suitably, the carbohydrate component comprises a maltodextrin. Alternatively, the carbohydrate component is may comprise starch. Preferably the carbohydrate component comprises maltodextrin of low dextrose equivalent, for example a maltodextrin having a dextrose equivalent of 15% or less. The carbohydrate component may have an average molecular weight of greater than 1800.

Suitably, the carbohydrate component is not hygroscopic. The composition may be such that hygroscopic elements are minimised which may ensure that the composition readily gives up free water.

Suitably, the carbohydrate component, is used in an amount of between 250 g and 500 g per litre of final composition. The method may use a carbohydrate component in an amount of between 325 g and 425 g per litre of final composition, for example in an amount of around 375 g per litre of final composition.

The method may employ a number of distinct carbohydrate components but they may be used in a combined amount corresponding to the amounts given herein for “the carbohydrate component”.

Suitably, the ratio of carbohydrate component to first gelling agent is between 250:1 and 350:1 by weight, for example around 310:1 by weight.

Suitably, step (iii) is performed for between 10 minutes and 90 minutes, for example up to 60 minutes. The carbohydrate component and second gelling agent may be added over a period of between 5 minutes and 90 minutes. The mixture may then be stirred with heating for between a further 10 minutes and 60 minutes. This may ensure the carbohydrate component is fully dissolved and/or dispersed.

During step (iv) the mixture may contain carbohydrate at a level that is not normally stable in a cold solution. Suitably, on cooling of the mixture the carbohydrate may however remain dissolved.

Suitably, step (iv) comprises maintaining the mixture at a Suitably, temperature of between 75° C. and 100° C., for example between 80° C. and 95° C. Step (iv) may be performed at a temperature of at least 80° C., for example at least: 85° C.; 90° C. or 95° C. Step (iv) may be performed at a temperature of 100° C. or below, for example at or below: 95° C.; 90° C.; or 85° C.

Suitably, in step (iv) the components are mixed by stirring. Suitably, the stirring is continuous.

Suitably, step (iv) uses a high shear mixer to mix the components.

Suitably, step (iv) is performed in a jacketed steam pan. Suitably, step (iv) is performed in the same jacketed steam pan as step (iii).

Suitably, step (iv) comprises adding water to adjust, for example to maintain, the volume of the composition. Suitably, said water is added in an amount of about 10% of the amount of water in the final composition.

The water may be added cold but the mixture may be heated to maintain its temperature as the water is added.

Suitably, method uses water in an amount such that the ratio of water to carbohydrate component in the final composition is between 1.5:1 and 2.5:1 by weight, for example around 2:1 by weight.

The method may use water in an amount such that the final composition comprises water in an amount of between 0.5 litres and 0.9 litres per litre of final composition, for example around 0.65 litres per litre of final composition.

Suitably, step (iv) is performed for between 10 minutes and 60 minutes, suitably between 20 minutes and 40 minutes, for example around 30 minutes. Water may be added throughout this time.

Step (v) suitably comprises the mixture transforming from a flowable liquid to a gel at a transition temperature of around 40° C.

Suitably, step comprises transferring the mixture to a vessel to cool. Suitably, said vessel comprises a sterile tank which is suitably sealed. Suitably, the mixture is not agitated or otherwise mixed while cooling.

Step (v) may comprise separating the mixture into portions and/or filling moulds or containers, for example sachets, with the mixture. This step may be performed whilst the mixture is warm. The mixture may for example be transferred into sachets and then allowed to cool and set. The mixture may be transferred substantially as soon as step (iv) is complete and may thus be at 75° C. or more. Thus, the method may comprise a hot-fill process. Alternatively it may be transferred once it has partially cooled but before it sets.

Suitably, during step (v) the mixture is allowed to cool to ambient temperature, suitably after having been separated into portions and/or filled into containers, for example sachets.

Step (v) may include a filtering step. Suitably the mixture is passed through a filter to remove particles greater than 0.5 mm.

Suitably, the method pasteurises the nutritional composition during production. Thus, a minimum amount of preservative may be required. Minimising the level of preservative may minimise the number of molecules in solution and may thus allow more carbohydrate to be added. Minimising the level of preservative may also allow the mixture to have a higher pH. The preservative may be more effective at a lower pH. pH may be controlled by, for example, the addition of citric acid. If a lower amount of preservative is required, a lower amount of citric acid may be added. This may allow for carbohydrate to be included at greater levels whilst maintaining the nutritional composition below the isotonic limit.

The nutritional composition may comprise one or more of flavour enhancer; anti-oxidant; preservative; flavourings; and/or sweetener.

Suitably, the method comprises adding one or more of flavour enhancer; anti-oxidant; preservative; flavouring; and/or sweetener in step (iv).

Suitably, the method comprises adding a flavour enhancer. The flavour enhancer may comprise sodium chloride. Suitably, the flavour enhancer is added in an amount of around 0.01 to 0.5 g per litre of final composition, for example in an amount of around 0.1 g per litre of final composition.

Sodium chloride may be added to enhance flavour and/or to provide positive ions which may activate the first gelling agent, suitably gellan gum. Suitably, sodium chloride is added in an amount of between 0.01 g and 0.5 g per litre of final composition, for example in an amount of around 0.1 g per litre of final composition, to activate gellan gum and may also serve as a flavour enhancer.

Suitably, the method comprises adding an anti-oxidant. The anti-oxidant may comprise, for example, ascorbic acid. Suitably, the anti-oxidant is added in an amount of between 0.005 g to 0.1 g per litre of final composition, for example in an amount of around 0.03 g per litre of final composition.

The method may comprise adding citric acid. Citric acid may drop the pH of the nutritional composition. This may ensure that the preservative works and may also improve the gel strength. For example, it may improve the gel strength of gellan gum. The citric acid may be added in an amount of between 0.01 and 5 g per litre of final composition, for example in an amount of around 1 g per litre of final composition.

Suitably, the method comprises adding a preservative. The preservative may comprise potassium sorbate and/or sodium benzoate, suitably both. Suitably, the preservative is added in an amount of between 0.01 g and 1 g per litre of final composition, for example in an amount of around 0.4 g per litre of final composition.

Suitably, the method comprises adding flavouring. The flavouring may comprise fruit flavouring. Suitably, the flavouring is added in an amount of between 1 g and 10 g per litre of final composition, for example in an amount of around 4 g per litre of final composition.

Suitably, the method comprises adding sweetener. The sweetener may comprise acesuphamine K. The sweetener may be added in an amount of between 0.05 g and 1 g per litre of final composition, for example in an amount of around 0.3 g per litre of final composition.

The nutritional composition may comprise nutrients and/or food supplements such as for example protein and/or caffeine and/or electrolytes. Suitably, these may be added to the mixture in step (iv). Suitably, such nutrients and/or food supplements are added in such amounts that the final composition comprises around 300 mmol of dissolved solids per litre.

According to a second aspect of the present invention there is provided a nutritional product which comprises carbohydrate in an amount of at least 250 g l⁻¹ of composition and is a gel.

Suitably, the composition has a tonicity of no greater than 350 mmol l⁻¹.

Suitably, the composition is manufactured according to the method of the first aspect.

The composition may comprise any feature as described in relation to the first aspect.

### BRIEF DESCRIPTION OF THE DRAWINGS

The present invention will now be illustrated by way of example with reference to the accompanying drawings in which:

FIG. 1 is a flow diagram illustrating a manufacturing method.

### DESCRIPTION OF THE PREFERRED EMBODIMENTS

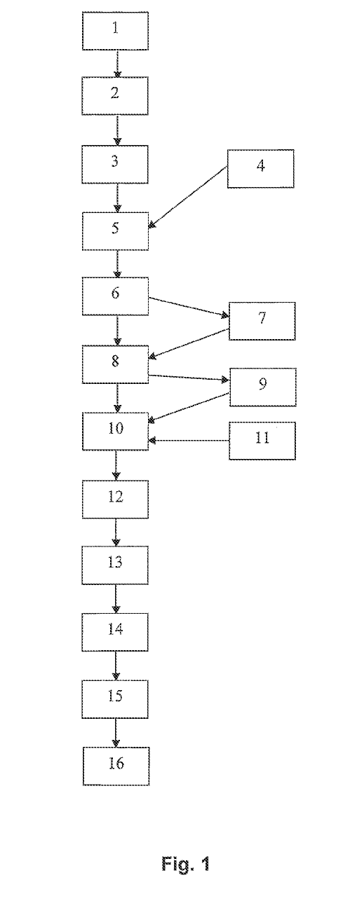

A nutritional composition comprising carbohydrate in an amount of 360 g l⁻¹ of composition was manufactured according to the method shown in outline by FIG. 1.

The items outlined by FIG. 1 are as follows:
1—Purchase
2—Delivery
3—Storage
4—Water
5—Weighing/Measuring
6—Mixing (i)
7—Heating (ii)
8—Mixing (iii)
9—Heating
10—Equalising (iv)
11—Water
12—Filtration and Transfer
13—Cooling
14—Analysis
15—Portioning/Packing
16—Storage

480 g of gellan gum (first gelling agent) and 160 g of sodium citrate (sequestrant) were combined with 280 litres of water in a jacketed steam pan at ambient temperature (step (i)). The gelling agent and sequestrant components were added simultaneously to the water and mixed with constant stirring by a high shear mixer.

The mixture held within the pan was then heated with to a temperature of between 80° C. and 90° C. (step (ii)). During this step the mixture was stirred continuously by the high shear mixer.

Following this a carbohydrate component was added to the mixture in the pan (step (iii)) together with 480 g of xanthan gum (second gelling agent). The carbohydrate component comprised 148.4 kg of a maltodextrin of low dextrose equivalent. Heating of the mixture was continued during this operation with the target temperature being 80° C. to 90° C. The xanthan gum and carbohydrate component were added to the mixture with constant stirring with the high shear mixer with the xanthan gum being added first.

During step (iii) a number of other components were also added to the mixture. These were 800 g orange flavouring; 800 g lemon flavouring; 400 g citric acid; 120 g acesulfamine K (sweetener); 80 g potassium sorbate (preservative); 80 g sodium benzoate; 40 g sodium chloride (flavour enhancer) 10 g ascorbic acid (anti-oxidant); and 1 g riboflavin (vitamin B2).

Step (iii) was performed over a period of 60 minutes with the components being added steadily over that time with mixing.

Following step (iii) the mixture was maintained in the pan at a temperature of between 80° C. to 95° C. and stirred constantly with the high shear mixer (step (iv)) to ensure full dissolution/dispersion of the carbohydrate. Water was added to the mixture steadily to adjust its volume over a period of 30 minutes to adjust and maintain the total volume at 400 litres.

Finally, the mixture was removed from the pan and allowed to cool below 40° C. (step (v)) and then separated into portions.

The composition of the 400 litres of nutritional gel produced is shown by table 1.

TABLE 1

| Component | Amount/g |
|---|---|
| Water | 269,800 |
| Maltodextrin | 148,400 |
| Orange Flavouring | 800 |
| Lemon Flavouring | 800 |
| Gellan Gum | 480 |
| Xanthan Gum | 480 |
| Citric Acid | 400 |
| Sodium Citrate | 160 |
| Acesulfame K | 120 |
| Potassium Sorbate | 80 |
| Sodium Benzoate | 80 |
| Sodium Chloride | 40 |
| Ascorbic Acid | 10 |
| Riboflavin | 1 |

This composition comprised a gel having carbohydrate in an amount of about 360 g l⁻¹ of composition and a tonicity of less than 350 mmol l⁻¹.

In an alternative embodiment, step (v) of the method can be modified by transferring the mixture containers immediately upon the end of step (iv).

It will be appreciated that preferred embodiments of the present invention may provide a method of manufacturing a nutritional composition for athletes and active people which comprises a significant level of carbohydrate as an energy source.

Such compositions may be light on the stomach, easy to administer, easy to digest and promote hydration. Such compositions may allow the time when persons consume a significant energy boost to be managed independently of their hydration requirements. The ingestion of water or other hypotonic solution for re-hydration may thus be consumed sometime before, during, or after consumption of the gel.

The method of preferred embodiments may ensure that the nutritional composition does not break down too easily, and the carbohydrate does not come out of solution during manufacture. The method may give the nutritional composition properties that may ensure the duodenal osmo-receptors do not act to slow gastric emptying. It may also ensure a very palatable product that has a relatively long shelf life.

Nutritional compositions made by the method of preferred embodiments may comprise an isotonic gel which combines higher molecular weight carbohydrate with a gelling agent. Such compositions may be gels or jelly like compositions which are stable, have good mouth-feel, a tonicity of no greater than 350 mmol l⁻¹, and can be packaged so that they can be easily carried and consumed.

The nutritional composition of preferred embodiments may facilitate a significantly lower fall in blood volume and a greater rise in blood glucose during exercise than known fluid replacements.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extends to any novel one, or any novel combination, of the features disclosed in this specification (including any accompanying claims, abstract and drawings), or to any novel one, or any novel combination, of the steps of any method or process so disclosed.

1-33. (canceled)

34. An isotonic nutritional gel composition comprising:
a carbohydrate component in an amount of at least between 250 g/L and 500 g/L of the composition;
a first gelling agent in an amount of between 0.5 g/L and 2 g/L of the composition;
a second gelling agent in an amount of between 0.5 g/L and 2 g/L of the composition; and
water, wherein the composition comprises at least 1000 Kcal/L of the composition.

35. The isotonic nutritional gel composition according to claim 34, wherein the carbohydrate component is present in an amount of between 325 g/L and 425 g/L of the composition.

36. The isotonic nutritional gel composition according to claim 34, wherein the ratio of carbohydrate component to first gelling agent is between 250:1 and 350:1 by weight.

37. The isotonic nutritional gel composition according to claim 34, wherein the ratio of water to carbohydrate component in the final composition is between 1.5:1 and 2.5:1 by weight.

38. The isotonic nutritional gel composition according to claim 34, wherein the first gelling agent is present in an amount of between 0.001 g and 0.005 g per 1 g of carbohydrate component, and the second gelling agent is present in an amount of between 0.001 g and 0.005 g per 1 g of carbohydrate component.

39. The isotonic nutritional gel composition according to claim 34, wherein the carbohydrate component is present in an amount that does not exceed its limit of solubility in the nutritional composition.

40. The isotonic nutritional gel composition according to claim 34, wherein the carbohydrate component has an average molecular weight of greater than 1800.

41. The isotonic nutritional gel composition according to claim 34, wherein the carbohydrate component comprises maltodextrin and/or starch.

42. The isotonic nutritional gel composition according to claim 34, wherein the carbohydrate component is non-hygroscopic.

43. The isotonic nutritional gel composition according to claim 34, wherein the first gelling agent is present in an amount of between 0.8 g/L and 1.6 g/L of the composition, and the second gelling agent is present in an amount of between 0.8 g/L and 1.6 g/L of the composition.

44. The isotonic nutritional gel composition according to claim 34, wherein the first gelling agent is selected from gellan gum and xanthan gum.

45. The isotonic nutritional gel composition according to claim 34, wherein the second gelling agent is selected from gellan gum and xanthan gum.

46. The isotonic nutritional gel composition according to claim 34, wherein the first gelling agent is gellan gum and the second gelling agent is xanthan gum.

47. The isotonic nutritional gel composition according to claim 34, comprising 50-70 wt % water.

48. The isotonic nutritional gel composition according to claim 34, wherein the composition is substantially free of particles greater than 0.5 mm.

49. The isotonic nutritional gel composition according to claim 34, wherein the composition has a tonicity of no greater than 350 mmol l⁻¹.

50. The isotonic nutritional gel composition according to claim 34, wherein the composition has an osmolality of between 270 and 330 mOSmol l⁻¹.

51. The isotonic nutritional gel composition according to claim 34, wherein the composition additionally comprises a sequestrant in an amount of between 0.0005 g and 0.005 g per 1 g of carbohydrate component.

52. The isotonic nutritional gel composition according to claim 34, wherein the composition additionally comprises a sequestrant such that the ratio of sequestrant to first gelling agent is between 1:2 and 1:4 by weight.

53. The isotonic nutritional gel composition according to claim 34, further comprising a food supplement selected from protein, caffeine, and electrolytes.
